(19) United States
(12) Patent Application Publication
(10) Pub. No.: US 2017/0108959 A1
(43) Pub. Date: Apr. 20, 2017

(54) TWO PIECE LENS ASSEMBLY

(71) Applicants: Richard Keith McMillan, Dearborn, MI (US); Robert Edward Belke, West Bloomfield, MI (US); Daren Lee Harris, Gilbert, AZ (US)

(72) Inventors: Richard Keith McMillan, Dearborn, MI (US); Robert Edward Belke, West Bloomfield, MI (US); Daren Lee Harris, Gilbert, AZ (US)

(21) Appl. No.: 14/884,029

(22) Filed: Oct. 15, 2015

(51) Int. Cl. G06F 3/041; G02B 1/11

(52) U.S. Cl. CPC G06F 3/041; G02B 1/11; B29D 11/00817

(57) ABSTRACT

A lens assembly for an electronic display, and a method of manufacturing said lens assembly is provided herein. The lens assembly includes a first lens layer, the first lens layer defining a surface opposing a viewer of the lens assembly; a second lens layer opposing a second surface of the first lens layer, the second surface being on an opposite side of the surface; a reservoir formed by the first lens layer and the second lens layer placed on a border, a liquid optical clear adhesive (loca) deposited into the reservoir; and a touch sensor attached to either the first lens layer and the second lens layer.

### BACKGROUND

Displays, such as electronic displays, are installed in various locations and contexts. For example, displays may be installed in an advertisement, a wall, or more commonly, vehicles.

The electronic displays include a lighting element—for example, light emitting diodes (LED), liquid crystal displays (LCD), and other types of lighting elements. The lighting elements may be attached or electrically coupled to a circuit element, and in response to the circuit element being propagated electrical signals, the lighting elements may variably provide indicia of different information.

The electronic displays are often times poke through devices with all the optical requirements provided by surface treatments and films on the electronic display surface. A poke through device refers to the actual display position. In convention displays, the thin film transistor (TFT) pokes through a hole in the instrument panel. Recent styling trends have led to these displays being placed behind a decorative lens and thus, the lens are required to take on the optical requirements of the displays. The lenses are of a transparent-type that allow light to pass through. The lens may be provided with a panel or some sort of fastening device to ensure the lens is maintained in a stable position. The lens also is required to meet all styling requirements including three-dimensional (3D) “A” surface geometry while still providing all regulatory, homologation, durability and environmental requirements.

Due to recent styling trends, the electronic displays have been incorporated with additional functionality. One of those functionalities is a touch screen interface. Thus, the complexity of the various componentry listed above has increased.

Further, as electronic displays are installed in certain environments and seamless design themes, the demands on the lens may be such that the optical qualities of the display are now a required feature of the lens and durability and adherence to vehicle interior homologation will now be required. The optical qualities may refer to: control over specular and diffuse reflections, control over light scattering (anti-glare) properties, control over the fingerprint reduction on the user interface surface, and control over stress induced birefringence. Thus, designing a lens system that provide a high quality optical performance with touch technology as well as meeting durability, environmental, chemical and impact resistance that is both thin, aesthetically pleasing and cost effective may be a difficult challenge.

In lens production, the following production techniques are used or implemented for adhesives:

1) Single shot—a part that with a single resin;

2) Two shot—a part with two different cavities in the tool with two different resins; and

3) Multi-shot—two or more resins in a single part.

FIG. 1(a) illustrates an example of a lens assembly 100 according to a prior art implementation.

The lens assembly 100 is shown with a display 110. The display 110 is an electronic display capable of communicating with a central processor, and configured to render information on the display 110.

The single piece lens design can be a single or multiple shot molded lens 150 and include multiple surface treatments 140. As shown in FIG. 1(a), these multiple treatments may be In Mold Decoration (IMD) or In Mold Lamination (IML), decorated as well as natural or color modified resin with additional secondary process decoration. The following additions may also be added, such as hard coating, anti-reflection coating, anti-glare coating, and anti-fingerprint coating.

These touch lenses are often flat but have been known to have a slight single axis of curvature and use multiple decoration and optical coating techniques 140. The lenses can include “dead front” technology.

The lens shown in FIG. 1(a) also has an air gap design between the lens and display that requires low reflection films 120 to achieve the optical requirements.

The laminating employed for the assembly 100 shown in FIG. 1 of the touch sensor 130 is dry optical clear adhesive (OCA). This bonding satisfies the optical requirements for the assembly 100.

Another issue is that current manufacturing limits are an inhibiting factor in including all the optical and decorative “requirements” in a one lens setup.

### SUMMARY

The following description relates to the two piece lens design. Exemplary embodiments may also be directed to the two piece lens assembly, and a method of manufacturing said two shot lens.

The lens assembly includes a first lens layer, the first lens layer defining a surface opposing a viewer of the lens assembly; a second lens layer opposing a second surface of the first lens layer, the second surface being on an opposite side of the surface; a reservoir is feature between the 2 lenses will control the flow of a liquid optical clear adhesive (LOCA) deposited between lens 1 and 2; and a touch sensor attached to either the first lens layer or the second lens layer.

A method for manufacturing a two shot lens assembly, such as a multi-shot, two lens assembly, which includes providing a display, the display providing lighting information rendered via digital information; attaching a touch sensor to a first lens layer or a second lens layer; bonding the first lens layer to the second lens layer via a liquid optical clear adhesive (LOCA); and bonding the bonded lens layers to the display.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIG. 1(a) illustrates an example of a lens assembly according to a prior art implementation.

FIGS. 1(b) and FIG. 1(c) illustrate an example of the two piece lens assembly with a touch sensor mounted in two different positions.

FIG. 2 illustrates lens-to-lens surface configurations

FIG. 3 illustrates assembly combinations.

FIG. 4 illustrates an example of a method for manufacturing the two shot lens according to the aspects disclosed herein.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

Disclosed herein are various lens assemblies, and methods of manufacturing said lens assembly according to a two-lens configuration. By employing two-lenses, a stable and reactive lens assembly is achieved. The configurations disclosed herein provide a robust and beneficial solution to the problem of providing a lens, touch sensor and a display.

As described in more detail below, the techniques described herein provide for multiple configurations of shapes based on the multi-lens configurations disclosed. Thus, by providing a solution as described below may be implemented by various manufacturers and consumers of digital displays.

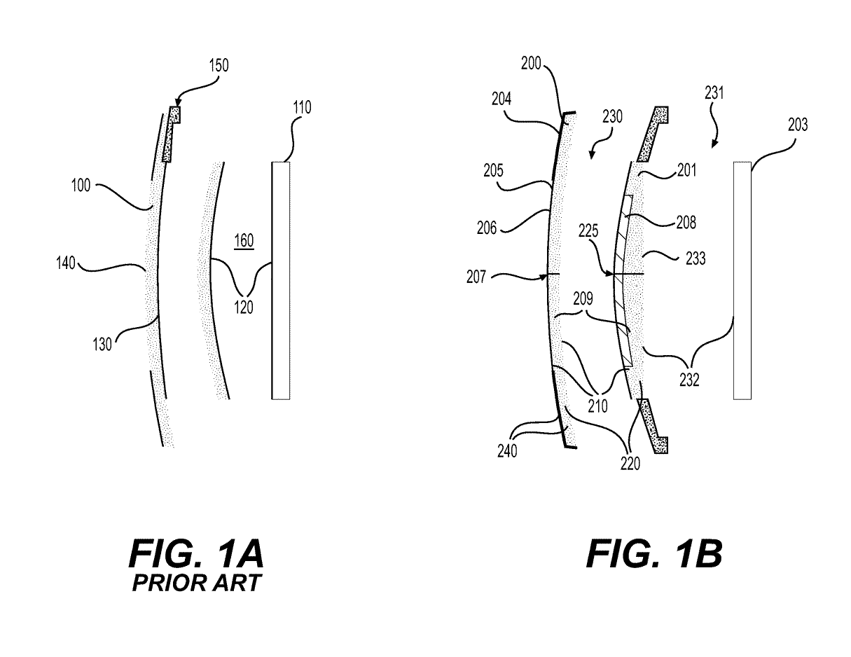

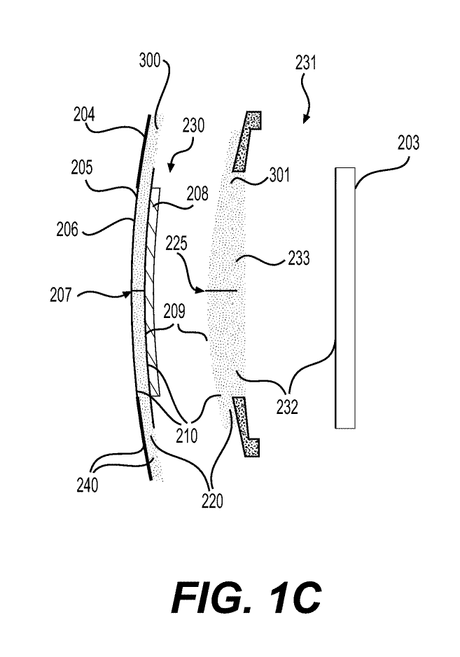

FIGS. 1(b) and (c) illustrate example of the two-piece single or multi-shot lens design according to an exemplary embodiment.

FIG. 1(b) shows the two-piece lens design assembly with a lens 2 (201) incorporated with a touch sensor 208. FIG. 1(c) shows the lens design assembly with a lens 1 (300) incorporated with a touch sensor 208.

Both systems ultimately provide, once assembled a single piece 3D “final” lens assembly that incorporates multi-decoration, multi-optical properties within a multi-shot lens that meet decorative, optical, durability, environmental and homologation requirements (multiple combination options are required not only for features and performance but also for geometry) that are not possible to meet with the lens assembly shown in FIG. 1(a). The geometry may refer to multiple geometry types.

Lens to Lens Surface Combinations:

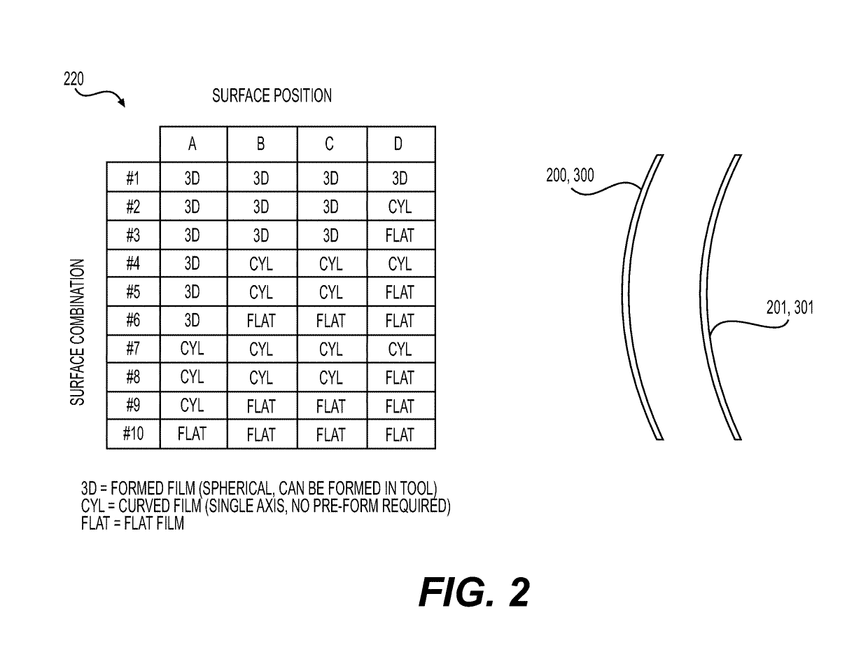

As explained above, multiple surface geometry's can be realized within with the design shown in FIGS. 1(b) and (c). FIG. 2 illustrates an example table 220 of the various permutations of shapes used with the lens 1 (200 and 300) and lens 2 (201 and 301). Each lens has a first surface and second surface. Lens 1 (200 and 300) has a first surface ‘A’ which opposes a viewer of the lens assembly, and a second surface ‘B’. Lens 2 has a first surface ‘C’ which opposes a viewer of the lens assembly, and a second surface ‘D’.

2 Piece Lens Design System Assembly Combinations:

With the different permutations shown in FIG. 2, table 220—different assembly options may also be available. Specifically, touch sensor 208 may be affixed to the overall assembly employing a variety of assembly techniques, including (but not limited to), lamination and in-molding.

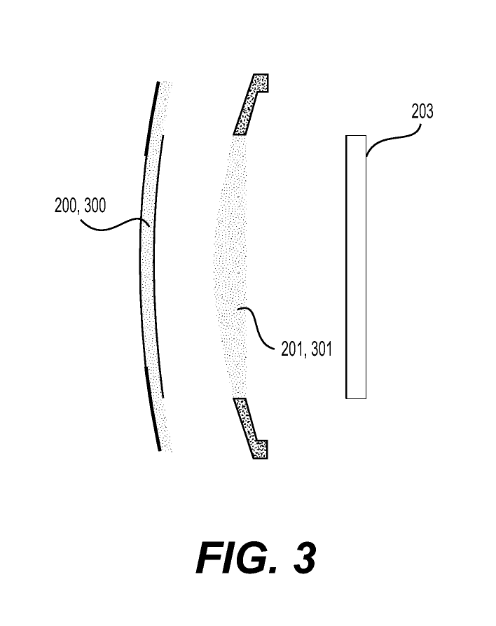

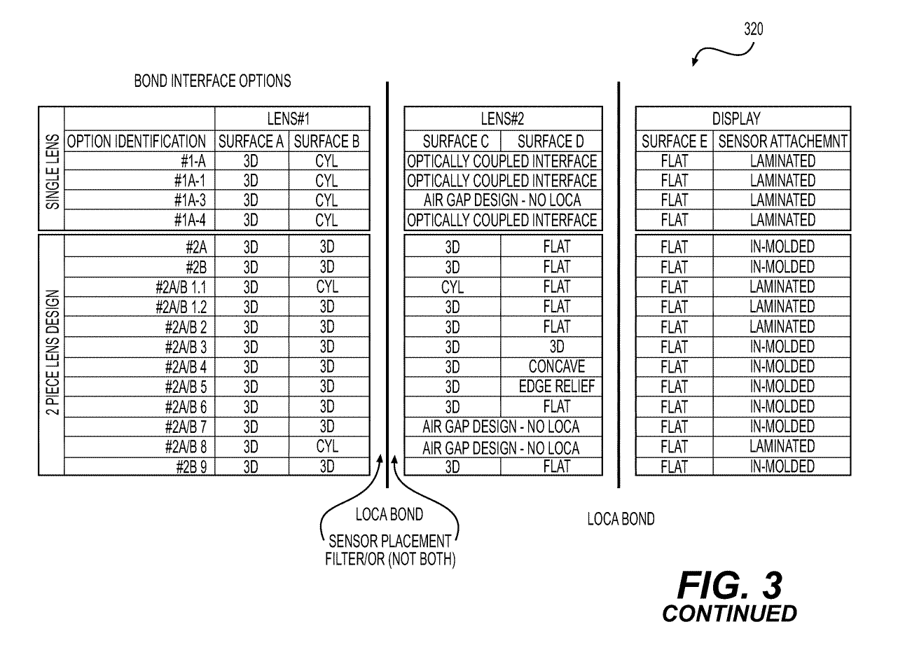

FIG. 3 shows a table 320 with a variety of method options for attaching the sensor for the correlated shape permutation. Also introduced in FIG. 3 is surface ‘E’ of the display 203. Surface ‘E’ is glass (or in other example, covered with film or a polymer based film), while the material between the lens is plastic. Also, the material between lens 2 (201 and 301) and the display 203 is also plastic and/or polymer. The various combinations that may be achieved with the lens 1 and 2 combination are:

lens 1 to 2 combinations:

PLASTIC/LOCA/PLASTIC

PLASTIC/GLASS/LOCA/PLASTIC

PLASTIC/LOCA/GLASS/PLASTIC

Lens 2 to display:

PLASTIC/GLASS

PLASTIC/PLASTIC/GLASS

GLASS/GLASS

GLASS/GLASS/GLASS

GLASS/PLASTIC/GLASS

The table 320 also shows that in some implementations, a front lens may solely be provided.

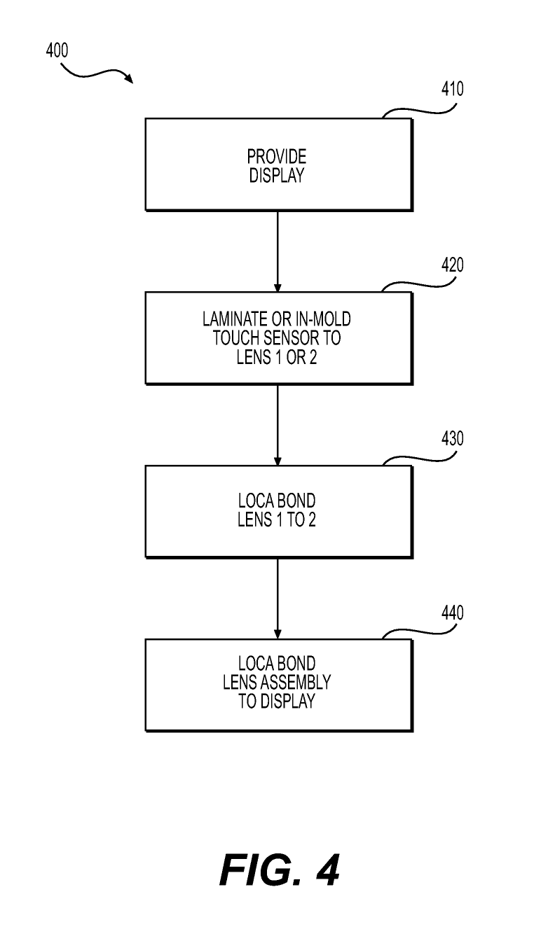

The assembly process is lens 1, 200 & 300 is bonded to lens 2, 201 & 301. After which, two lens assembly is bonded to the display 203. This method will be explained in greater detail in FIG. 4.

Once again, referring back to FIGS. 1(b) and FIG. 1(c), the lens assembly includes a display 203 (similar to the example shown in FIG. 1(a)). The display 203 provides back-lighting and is configured to render lighted information through the transparent lens, with the light being visible to a viewer of the lens assembly. Also similarly provided is a touch sensor 208. The touch sensor 208 provides the capability of recording touches and other engagements onto the lens assembly (for example with a finger, stylus pen, or other object).

Employing the aspects shown in FIGS. 1(b) and (c), by placing the touch sensor 208 between lens 1, 200 & 300 and lens 2, 201 & 301, an implementer of the lens assembly may achieve various advantages. Because a second lens layer 201 & 301 is provided, an even layer may be placed in front of the touch sensor 200 & 300. This allows for significant improvements the touch sensor 208's performance.

Another advantage is that because a separate layer (with a significant even thickness) is used for first lens layer 200 & 300, a smoked resin may be employed for the first lens layer.

Another advantage (if in-tool lamination is used) is that the touch sensor 208 is not post-mold laminated (or needed to be laminated) in certain implementations. By obviating this step, one manufacturing process is removed.

The lens assemblies shown in FIGS. 1(b) and (c) may provide a more compliant solution with a variety of head impact tests. Another advantage is that if injection compression is used with an isotropic touch sensor, the birefringence issues may be minimized.

Further, because the two-lens approach is used, including attachments may not hinder the quality of the front lens. Additionally, since multiple lens are used, multiple types of materials may be realized.

FIG. 4 illustrates an example of a method 400 for manufacturing the two shot lens according to the aspects disclosed herein. Referring to FIG. 4, method 400 may be implemented in a variety of situations and contexts.

In operation 410, a display is provided. The display may be an electronic display capable of rendering light through a transparent surface. In operation 420, the touch sensor is either laminated or in-molded to the surface which it is attached to. As shown in the FIG. 3, the laminating or in-mold step may be selectively chosen based on the surfaces implemented for the variety of lenses.

In operation 430, a LOCA layer is applied to either the first lens or the second lens, in a manner to adhesively attach the lenses. In operation 440, the resultant attached lens assembly is LOCA bonded to the display provided in operation 410.

Employing the aspects disclosed herein, a lens assembly implemented with a more responsive touch sensor may be achieved. Because a LOCA reservoir is provided, different frames may be realized and more robust designs may be implemented.

The front surface decoration methods can be achieved with In-mold decoration, In-Mold lamination or any other “A” surface decoration techniques that are available to achieve the desired look

The optical coatings 205 to achieve the required optical system performance can be applied in the tooling through tooling methods or coatings as well as in the films and foils or applied via secondary operations like, but not restricted to dip, spin, vapor deposition, and spray coating (single and multiple layers) plus additional thin film deposition techniques, such as anti-reflective film, anti-glare film, and other film types known.

The display border 204 may be used to hide any sensor film edges, for example the second shot features from lens 1 (200 or 300) or lens 2 (201 and 301) plus the display edges 203. The method to apply this can be accomplished by the use of films, foils, resin, screen and gravure printing, or other secondary processes.

The thickness of the lenses 207 and 225 is driven by the optical stack required and tunable in this design either via lens 1 (200 and 300) or lens 2 (201 and 301).

Methods to control molded-in stresses (birefringence) are available in the manufacturing or stack-up processes via tooling or injection mold machine methods, as well as with the addition of enhancement films and base resin selections. This can also be a factor of thickness, 207 and 225, plus material selection. Configuring the lens assembly by choosing a specific touch sensor conductor may also control birefringence.

It is possible to laminate or integrate via the molding process the touch sensors between lens 1 (200 and 300) plus lens 2 (201 and 301). These can be dry or wet bonding methods.

Lens 2 (201 and 301) may not be an injection molded part. Other manufacturing techniques could be utilized to manufacture this piece although injection molding is the prime path.

Multiple dead front 240 options are achievable in this design including but not limited to screen printing, gravure printing, resin type and custom “A” surface film development. The concept of dead front 240 is defined as Dead front is a term used to limit the users view of what is behind the lens. Essentially it is a way to darken the clear lens so that when the display is OFF the user cannot see what is behind the lens. Another way to define this is transmission. What the level of transmission is through the lens. 25%, 50% 75%, etc.

Multiple materials can be used to manufacture lens 1 (200 and 300) and lens 2 (201 and 301). Materials types will be driven by meeting homologation requirements as well as optical and decorative requirements. Material selection between the lenses does not have to be the same. Each lens can have a different material.

Lens 1 (200 and 300) and lens 2 (201 and 301) have the ability to have multiple surface topologies to suit bonding and optical requirements. Lens 2 (201 and 301) have the ability to have multiple rear surface topology to suit bonding techniques.

By employing the aspects disclosed herein, the following advantages may be realized:

1. The strain on an electronic display may be lessened due to eliminating the variable bond line thickness.

2. A strengthening rib may be added to the front lens, and it may be provided in a hidden manner so that it is behind the display border to help control post mold warpage.

3. The edge strength of the bond line may be increased due to the ability to control the lens 2 surface geometry.

4. Elimination of the need for a dry lamination process of the touch sensor.

5. Provides LOCA over run positions at both the lens to lens and lens to display bond lines. 6. Second shot, Second lens features provide fixing and location points for the display.

7. Eliminates the need for a two shot two film part—which is a very low yield process (however, with the methods disclosed herein, a two shot and two film part may still be used).

8. A three shot two film IML process or three shot IML and IMD process may be implemented. This produces a three shot multi-film and multi-decoration method that is not available with current automated manufacturing processes for single lens designs.

9. Two shot front lens may be wrapped around the second shot over the sensor edges to eliminate delamination issues if a single lens design is used.

10. Allows for the manufacturing of an even thickness three dimensional touch surface to increase sensor performance.

11. Allows for an even thickness 3D front lens for an even dead front appearance.

12. Reduces the strain caused by LOCA expansion during environmental cycles which eliminates mura issues on the display—Mura is a Japanese word meaning “unevenness; irregularity; lack of uniformity; non-uniformity; inequality”.

13. Allows for the sensor to be as close as 1.5 mm, or closer, from the front surface, which increases the sensor performance during a gloved operation (which is usually not possible with a capacitive touch technologies).

14. Allows for strengthening the bond lines by adding additional adhesive options and geometry combinations.

15. Allows for the added location and mechanical fixing features between the front and rear lens.

16. Allows for the added location and fixing features on the second lens in order to keep the high quality of the “A” surface on the first lens.

17. Provides for multiple material combinations and material stacks to help survive head impact testing.

18. Allows for several possibilities to eliminate birefringence including, but not limited to molding processes, materials combinations and tooling techniques.

19. Allows for the mixing and matching of decoration techniques to satisfy customer design requirements.

20. Allows for the mixing and matching of optical coating techniques included IML and IMD front surface films, and foils plus secondary operations to satisfy optical requirements.

21. Allows for the utilization of several touch sensor technologies to minimize cost in the assembly.

22. Allows for the encapsulation of the sensor protecting it from environmental attack.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

We claim:

1. A lens assembly for an electronic display, comprising:
a first lens layer, the first lens layer defining a surface opposing a viewer of the lens assembly; and
a second lens layer opposing a second surface of the first lens layer, the second surface being on an opposite side of the surface;
wherein the first lens layer and the second lens layer are coupled to each other via an optically transmissive medium.

2. The lens assembly according to claim 1, wherein the transmissive medium is a liquid optical clear adhesive (loca).

3. The lens assembly according to claim 2, further comprising
a reservoir formed by the first lens layer and the second lens layer placed on a border, in which the loca is deposited; and
a touch sensor attached to either the first lens layer and the second lens layer.

4. The lens assembly according to claim 3, wherein the first lens layer is defined by a shape of being flat.

5. The lens assembly according to claim 3, wherein the first lens layer is defined by a shape of being three-dimensional (3D).

6. The lens assembly according to claim 3, wherein the first lens layer is defined by a shape of being cylindrical.

7. The lens assembly according to claim 3, wherein the second lens layer is defined by a shape of being flat.

8. The lens assembly according to claim 3, wherein the second lens layer is defined by a shape of being three-dimensional (3D).

9. The lens assembly according to claim 3, wherein the second lens layer is defined by a shape of being cylindrical.

10. The lens assembly according to claim 3, wherein the touch sensor is attached via an in-molding process.

11. The lens assembly according to claim 1, wherein the touch sensor is attached via a lamination process.

12. The lens assembly according to claim 2, further comprising a second LOCA layer, the second LOCA layer affixing the second lens layer with the display.

13. The lens assembly according to claim 1, wherein the first lens layer and the second lens layer are of a different shape.

14. The lens assembly according to claim 1, wherein the first lens layer and the second lens layer are of a different material.

15. The lens assembly according to claim 1, wherein the first lens layer and the second lens layer are of a different process other than injection molding.

16. The lens assembly according to claim 3, wherein the touch sensor is provided in-between the first and second lenses.

17. The lens assembly according to claim 1, wherein the first lens layer is affixed with a film.

18. The lens assembly according to claim 1, wherein the second lens layer is affixed with a film.

19. The lens assembly according to claim 1, further comprising a coupling frame for attaching the first lens layer and the second lens layer.

20. A method for manufacturing a two shot lens assembly, comprising:
providing a display, the display providing lighting information rendered via digital information;
attaching a touch sensor to a first lens layer or a second lens layer;
bonding the first lens layer to the second lens layer via a liquid optical clear adhesive (LOCA); and
bonding the bonded lens layers to the display.
